(19) United States
(12) Patent Application Publication
(10) Pub. No.: US 2026/0171566 A1
(43) Pub. Date: Jun. 18, 2026

(54) Battery Frame for a Battery Rack and Battery Rack Structure for an Electric Vehicle

(71) Applicant: Battle Motors, Inc., New Philadelphia,, OH (US)

(72) Inventors: Kelleigh Ash, New Philadelphia, OH (US); Mark Ward, New Philadelphia, OH (US); Reilly Foltz, New Philadelphia, OH (US)

(21) Appl. No.: 19/128,795

(22) PCT Filed: Nov. 15, 2023
(86) PCT No.: PCT/US23/79825

§ 371 Date: May 9, 2025

Related U.S. Application Data
(60) Provisional application No. 63/425,643, filed on Nov. 15, 2022.

(51) Int. Cl. H01M 50/209; H01M 50/244; H01M 50/249

(52) U.S. Cl. CPC H01M 50/209; H01M 50/244; H01M 50/249

(57) ABSTRACT

A battery frame has a generally planar rear member and a pair of opposing parallel generally planar side members extending generally orthogonally from the rear member. A pair of opposing coplanar top flanges extend generally orthogonally to the rear member and the side members and each outwardly from a respective side member and has a plurality of apertures spaced there along. A pair of opposing coplanar bottom flanges extend generally orthogonally to the rear member and the side members and each outwardly from a respective side member and have a plurality of apertures spaced there along and aligned with the apertures of the top flanges respective to each side. A pair of opposing coplanar inner flanges extending generally orthogonally to the rear member and the side members and each inwardly from a respective side member for support of a battery package disposed therein the battery frame.

### CROSS-REFERENCE TO RELATED APPLICATIONS

This application claims priority to and the benefit of U.S. Provisional Patent Application 63/425,643 filed 15 Nov. 2022, the contents of which are hereby incorporated by reference in their entirety.

### BACKGROUND

This relates in general to electric vehicles. There are personal and commercial electric vehicles, including passenger, cargo and utility vehicles. Generally, such vehicles include a battery or battery array to power one or more electric motors for propulsion of the vehicle.

Many vehicles are designed with a generally integrated battery or battery array, which is typically custom designed to the specific vehicle. Alternatively, some vehicles include more widely available batteries or battery arrays, but have a singular custom mounting to integrate the battery or battery array into the vehicle.

### SUMMARY

This relates more particularly to a battery frame for a battery rack and a battery rack for an electric vehicle

A battery frame has a generally planar rear member and a pair of opposing parallel generally planar side members extending generally orthogonally from the rear member. A pair of opposing coplanar top flanges extend generally orthogonally to the rear member and the side members and each outwardly from a respective side member and has a plurality of apertures spaced there along. A pair of opposing coplanar bottom flanges extend generally orthogonally to the rear member and the side members and each outwardly from a respective side member and have a plurality of apertures spaced there along and aligned with the apertures of the top flanges respective to each side. A pair of opposing coplanar inner flanges extending generally orthogonally to the rear member and the side members and each inwardly from a respective side member for support of a battery package disposed therein the battery frame.

In at least one embodiment the battery frame includes a cross support member extending between and coplanar to the pair of inner flanges.

In at least one embodiment the battery frame includes a pair of opposing coplanar rear flanges extending generally orthogonally to the rear member and the side members and one inwardly from a top edge of the rear member and the other from a bottom edge of the rear member. Additionally, the battery frame may further include at least one rear reinforcement member abutting the rear member and extending between the pair of rear flanges.

In at least one embodiment the battery frame includes at least one side reinforcement member abutting each side member and extending between respective top and bottom flanges.

In at least one embodiment each side member of the battery frame defines a window therein. Additionally, the window may be disposed at the end of each side member opposite the rear member.

In at least one embodiment the battery frame includes at least one pair of opposing connection tabs, one of each, extending laterally from a respective side member about an end opposite the rear member, and including an aperture disposed therein.

In further embodiments, the battery frame includes one or more of the features above in combination with another.

A battery rack assembly includes a pair of battery frames, as described above.

In at least one embodiment the battery rack includes a top cover disposed adjacent to the top flanges and having a plurality of apertures aligned with the apertures in the top flanges. Additionally, the top cover may defines a plurality of windows for the passage of environmental or electrical utilities or controls.

In at least one embodiment the battery rack includes a mounting structure disposed adjacent to the bottom flanges and including upper portions having a plurality of apertures aligned with the plurality of apertures in the bottom flanges. Additionally, the mounting structure may further includes a pair of opposing parallel mounting brackets extending in the direction between the side members for attachment to a vehicle frame. Further, the mounting brackets may be spaced from the upper portions with a pair of side plates extending there between. Also, at least one of the side plates may defines a window providing access to space below the pair of battery frames.

In at least one embodiment the battery rack further includes a second pair of battery frames as described above. where the bottom flanges of the second battery frames are disposed adjacent to the top flanges of the first battery frames with the apertures of the bottom flanges of the second battery frames aligned with the apertures in the top flanges of the first battery frames.

In at least one embodiment the battery rack may further include a pair of battery packages, one of each disposed in one of the battery frames and spaced apart with one another. Each battery package may include an electrical utility or control interface facing the spaced apart area between the battery packages.

In at least one embodiment the rear member of at least one of the battery frames defines a window therein to provide access to the space inside the one of the battery frames. Additionally, a battery package may be disposed within the one of the battery frames and include an electrical utility or control interface facing the rear member window or through the rear member window.

In at least one embodiment a lightweight battery rack to house EV batteries for a vehicle, such as a truck, is provided. The components of the rack are generally modular to allow for the rack to house the EV batteries in a plurality of configurations, and to be mounted in various location and orientation, such as in a variety of positions and locations on a truck chassis.

Various aspects will become apparent to those skilled in the art from the following detailed description and the accompanying drawings.

### BRIEF DESCRIPTION OF THE DRAWINGS

FIG. 1 is a front top side perspective view of a battery frame for a battery package.

FIG. 2 is a bottom front perspective view of the battery frame of FIG. 1.

FIG. 3 is a bottom side rear perspective view of the battery frame of FIG. 1, shown with an alternative arrangement of the side reinforcement member.

FIG. 4 is a front view of the battery frame of FIG. 1.

FIG. 5 is a side view of the battery frame of FIG. 1 shown with the alternative arrangement of the side reinforcement member.

FIG. 6 is a bottom view of the battery frame of FIG. 1.

FIG. 7 is a rear view of the battery frame of FIG. 1.

FIG. 8 is a front top side perspective view of a battery rack assembly including a plurality of the battery frame of FIG. 1.

FIG. 9 is a front view of the assembly of FIG. 8.

FIG. 10 is a top side perspective view of a pair of the battery frame of FIG. 1 each having a respective battery package disposed therein being joined together.

FIG. 11 is a view similar to FIG. 10, but with a pair of the battery frames joined together, and shown with the alternative arrangement of the side reinforcement member.

FIG. 12 is a front perspective view of a plurality of the pair of battery frames of FIG. 9 being joined together to form the assembly of FIG. 8.

FIG. 13 is a front top side perspective view of a battery rack structure for an electric vehicle including a battery rack assembly similar to the battery rack assembly of FIG. 8.

FIG. 14 is a rear view of the batter rack structure of FIG. 13.

FIG. 15 is a is an exploded view of the battery rack structure of FIG. 13 with the top cover removed.

FIG. 16 is an enlarged view of a portion of FIG. 15 taken at A.

### DETAILED DESCRIPTION

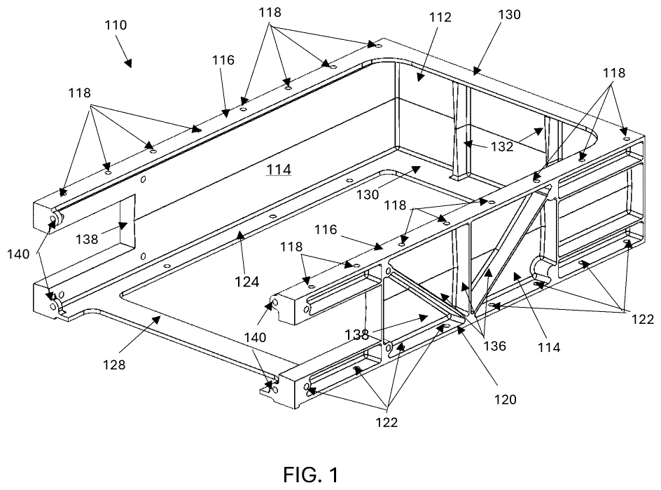

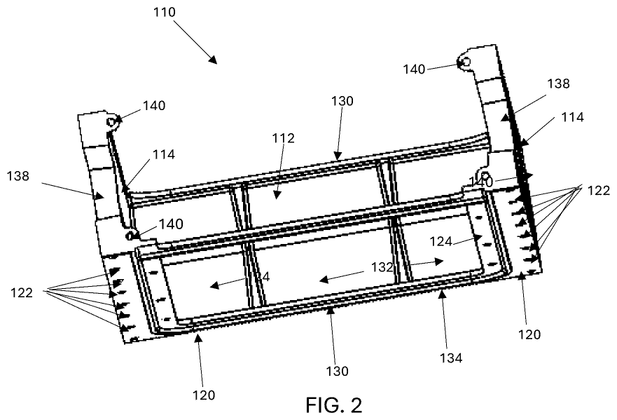

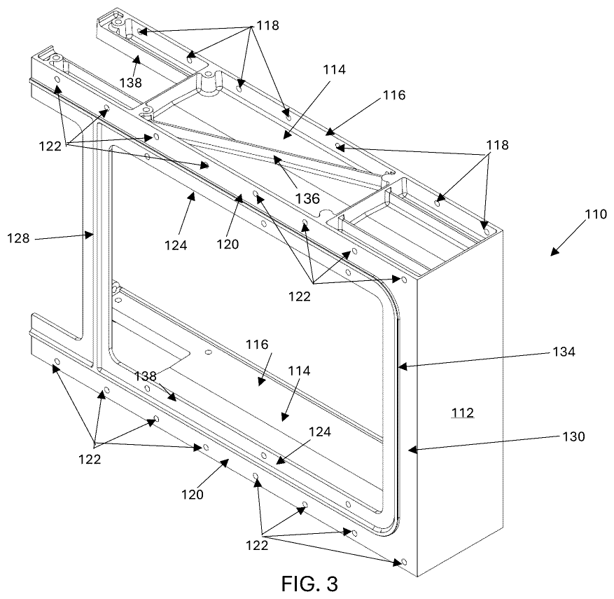

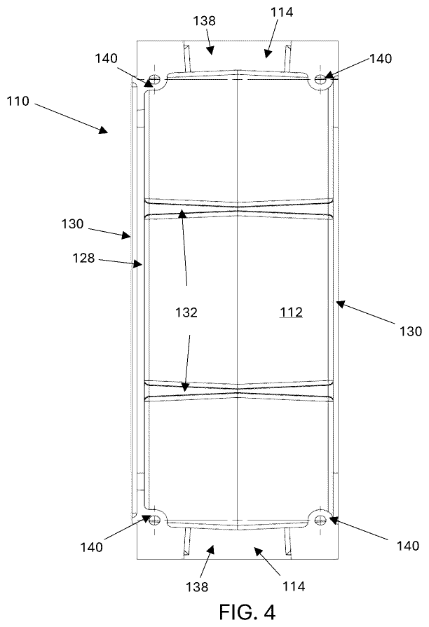

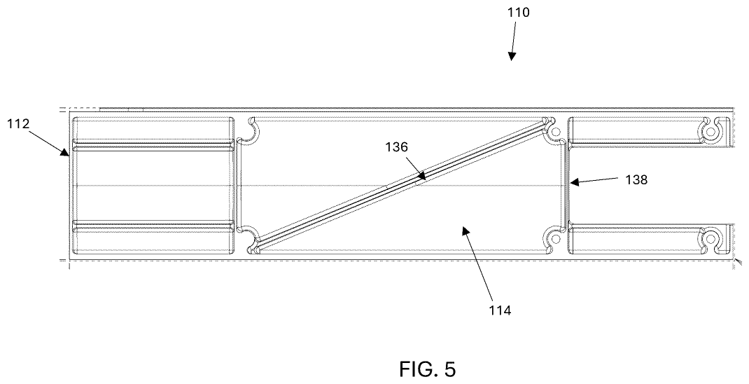

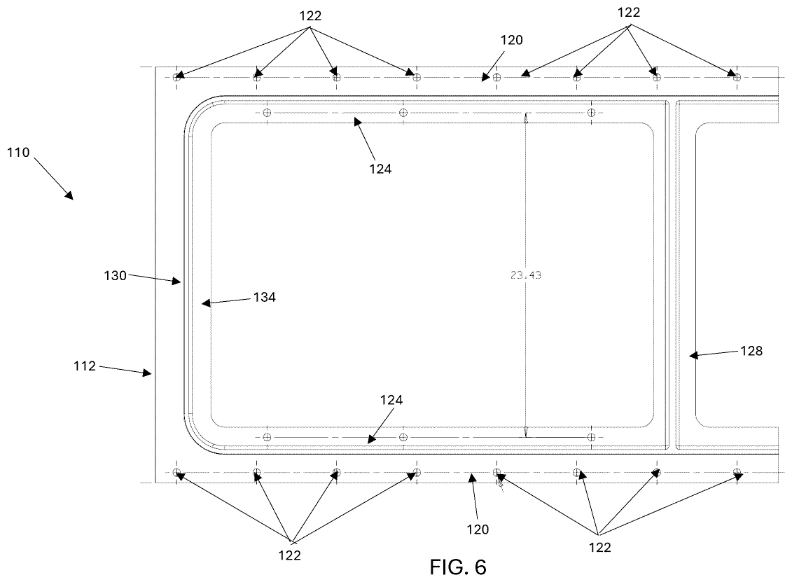

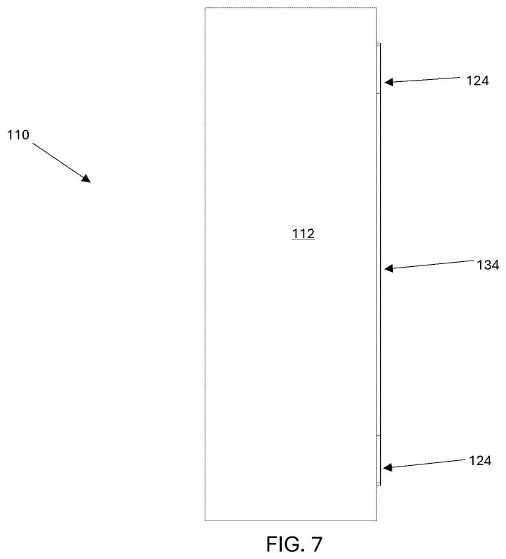

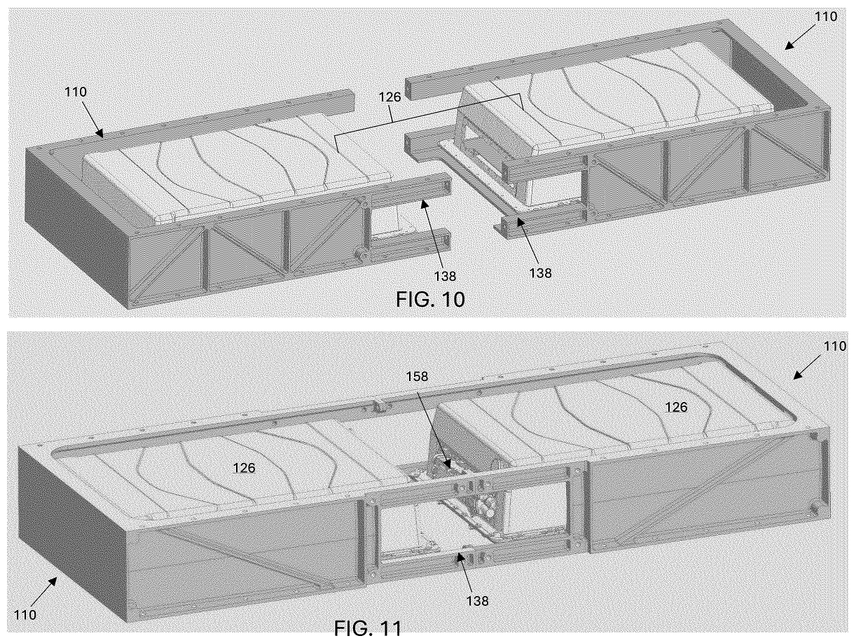

Referring now to the drawings, as best shown in FIGS. 1-7, there is illustrated a battery frame 110. The frame 110 has a generally planar rear member 112. A pair of opposing parallel generally planar side members 114 extend generally orthogonally from the rear member 112. A pair of opposing coplanar top flanges 116 extend generally orthogonally to the rear member 112 and the side members 114 and each extend outwardly from a respective side member 114 and has a plurality of apertures 118 spaced there along. A pair of opposing coplanar bottom flanges 120 extend generally orthogonally to the rear member 112 and the side members 114 and each extend outwardly from a respective side member 112 and have a plurality of apertures 122 spaced there along and are aligned with the apertures 118 of the top flanges 116 respective to each side. A pair of opposing coplanar inner flanges 124 extending generally orthogonally to the rear member 112 and the side members 114 and each extend inwardly from a respective side member 114 for support of a battery package 126, see FIGS. 10-12, disposed therein the battery frame 110. It must be understood that the battery package may be a single batter unit, a multi-battery, a battery array, or any other battery devise suitable for the storage and supply of an electric charge for a motor of an electric vehicle.

The battery frame 110 further includes and optional a cross support member 128 extending between and coplanar to the pair of inner flanges 124.

The battery frame includes a pair of opposing coplanar rear flanges 130 extending generally orthogonally to the rear member 112 and the side members 114 with one extending inwardly from a top edge of the rear member 112 and with the other extending from a bottom edge of the rear member 112. Additionally, the battery frame 110 includes an optional pair of rear reinforcement members 13, abutting the rear member 112 and extending between the pair of rear flanges 130, although any number in any orientation may be included.

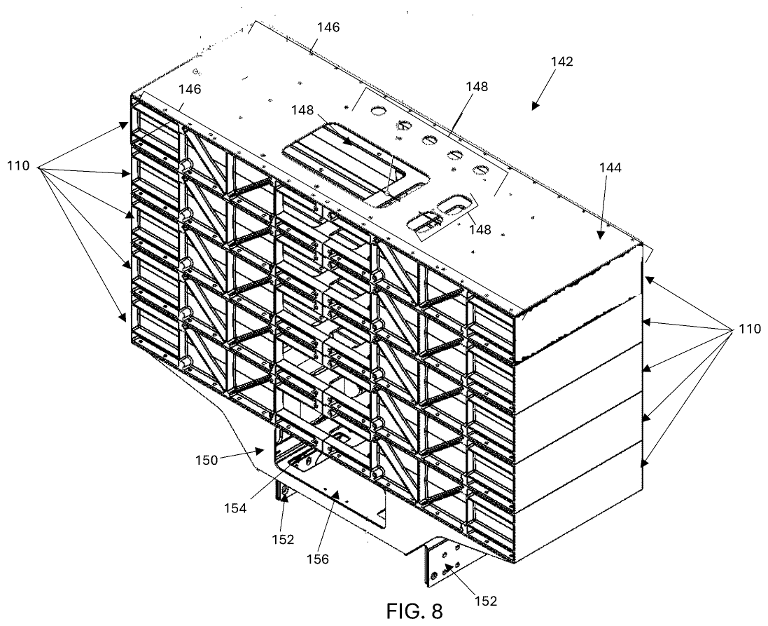

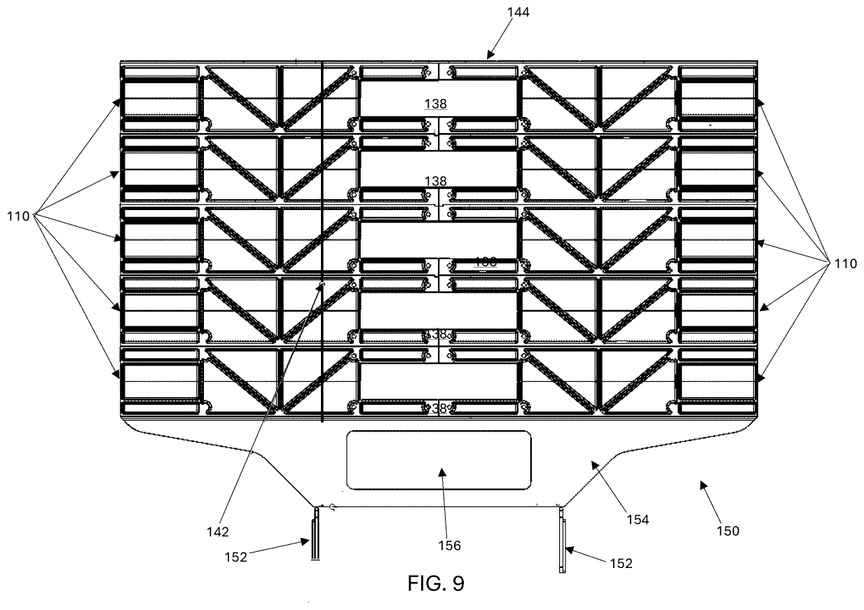

Additionally, the battery frame 110 includes an optional lip 134 extending from the bottom flanges 120 and bottom rear flange 130 of the bottom of the battery frame 110 that cooperates with the top flanges 116 and top rear flange 130 of another batter frame 110 when stacked to provide stability and support, see FIGS. 8-12.

The battery frame 110 also includes at least one optional side reinforcement member 136 abutting each side member 114 and extending between respective top and bottom flanges 116 and 120, although any number in any orientation may be included.

In the illustrated embodiment, each side member 114 of the battery frame 110 defines a window 138 therein. The window is disposed at the end of each side member 114 opposite the rear member 112. However, the window may be disposed anywhere in the side member 114 as desired.

The battery frame 110 includes at least one pair of opposing connection tabs 140, one of each extending laterally from a respective side member 114 about the end opposite the rear member 112, and including an aperture disposed therein.

The battery frame 110 may be cast, for example made of aluminum, steel, steel alloy, or other metal material, or formed from a plastic, such as a thermoplastic, additionally, the battery frame 110 may be formed by additive manufacturing, such as 3D printing. Further the battery frame 110 may be formed from pieces that have been stamped or pressed and joined together, or formed by any other suitable process.

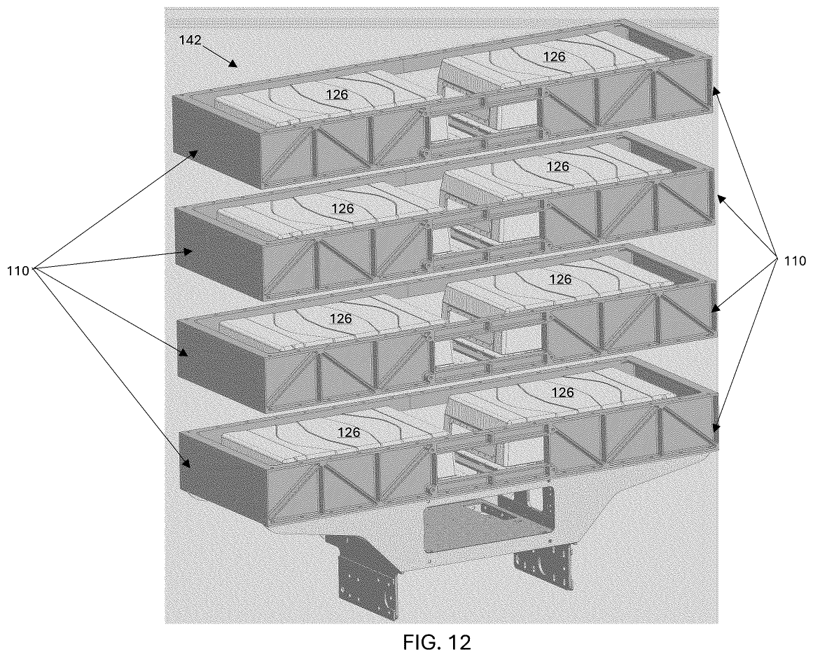

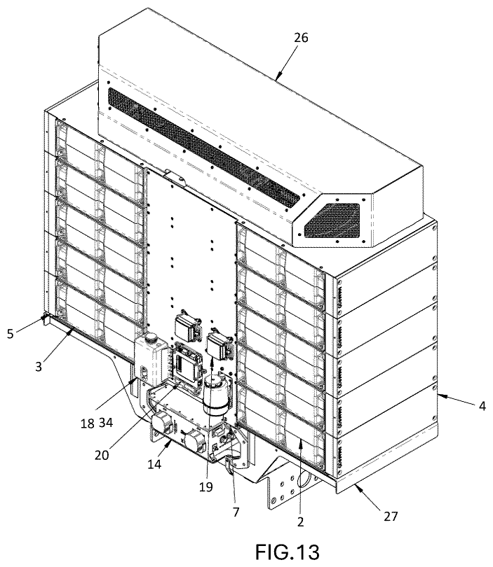

As best shown in FIGS. 8-12 a plurality of battery frames 110 may be joined together to form a battery rack assembly 142, as illustrated the battery rack assembly 142 includes a pair(s) of battery frames 110 joined together, see FIGS. 10 and 11, and stacked upon one another, see FIG. 12. as described above. The frames 110 may be assembled and secured together by using fasteners, such as screws, nuts and bolts, cotter pins, and the like, passed through the aligned apertures to join the battery frames 110 and other members of the rack assembly 142 together.

The battery rack assembly 142 includes an top cover 144 that is disposed adjacent to the top flanges 116 of the upper most pair of battery frames 110. The top cover 144 has a plurality of apertures 146 aligned with the apertures 118 in the top flanges 116 for the use of fasteners to join the top cover 144 to the upper pair of battery frames 110. Additionally, the top cover 144 defines a plurality of windows 148 for the passage of environmental or electrical utilities or controls. In operation, an environmental control unit, such as HVAC, other control unit, or electrical control or distribution unit, may rest upon top of the rack assembly 142 and be supported by the top 144. Alternatively, such units may be separately and/or independently mounted with connections passing through the windows 148.

The battery rack 142 also includes a mounting structure 150 disposed adjacent to the bottom flanges 120 of the bottom pair of battery frames 110. The mounting structure 150 includes upper portions having a plurality of apertures aligned with the plurality of apertures 122 in the bottom flanges 120 for the use of fasteners to join the mounting structure 150 to the bottom pair of battery frames 110. The mounting structure 150 also includes a pair of opposing parallel mounting brackets 152 extending in the direction between the side members 114 of the batter frames 110 for attachment to a vehicle frame. Further, the mounting brackets 152 are spaced from the upper portions with a pair of side plates 154 extending there between. As illustrated, at least one of the side plates 154 defines an optional window 156 which provides access to space below the pairs of battery frames 110.

It is contemplated that the battery frames 110 may be deployed in a variety of configuration, and as such, a battery rack 142 any number of pairs of battery frames 110, with the bottom flanges 120 of one battery frame 110 disposed adjacent to the top flanges 116 of the battery frame 110 below it with the apertures 122 of the bottom flanges 120 aligned with the apertures 118 in the top flanges 116 for each pair of battery frames 110 as they are stacked one on another.

Further, is must be understood that in arrangement the battery rack 142 may include a pair of battery packages 126, one of each disposed in one of the battery frames 110 of a pair of battery frames 110, and spaced apart with one another. In such an arrangement, each battery package 126 may include an electrical utility or control interface 158 facing the spaced apart area between the battery packages.

Further, it must be understood that in arrangement the battery rack 142 may include one or more battery packages 126 disposed in one or both of the battery frames 110 of a pair of battery frames 110, where the rear member 112 of the one or both of the battery frames 110 of the pair of battery frames defines a window therein to provide access to the space inside the one or both of the battery frames 110. Additionally, a battery package(s) 126 may include an electrical utility or control interface 158 facing the rear member window or through the rear member window.

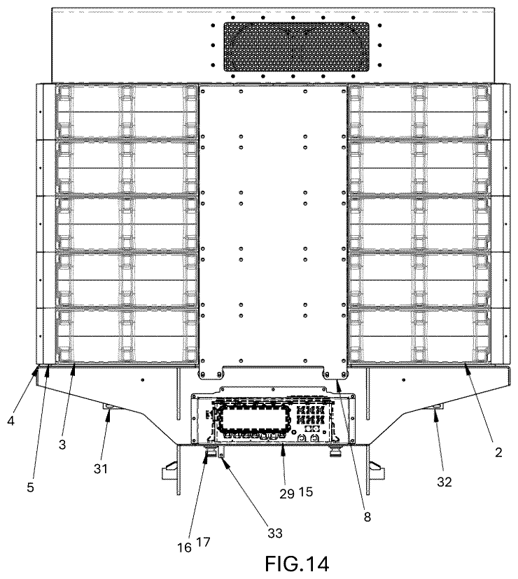

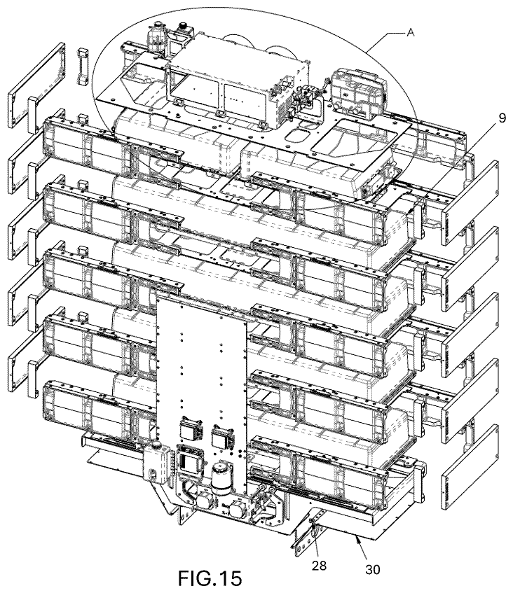

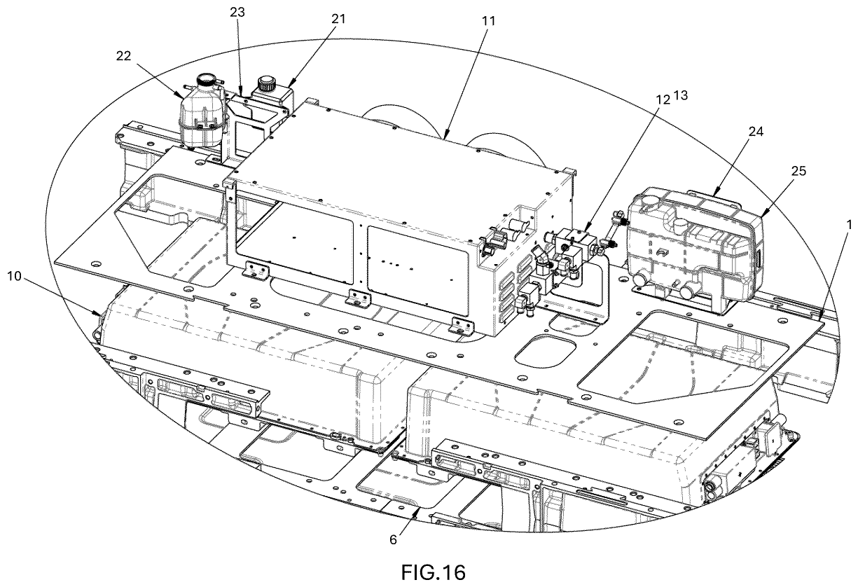

Referring to FIGS. 13-16 there is illustrated a battery rack structure for an electric vehicle including a battery rack assembly similar to the battery rack assembly as previously shown and described. Corresponding elements should be considered generally similar unless otherwise noted.

The batter rack structure includes A Battery Rack Top Plate 1, Right Side Battery Cases 2, Left Side Battery Cases 3, Battery Case End Caps 4, A Spacer 5, Battery Rack Case Floor Plates 6, An Electrical Rack Front Closeout Cover 7, An Electrical Rack Rear Closeout Cover 8, First Type of Battery Storages 9, Second Type of Battery Storages 10, A Heat Exchanger 11, A Coolant Tanks Assembly 12, A Water Reservoir Assembly 13, An Electro-Coulomb Control Box 14, Electronic Controls 15, Vibration Dampers 16, Washers 17, Washer-System Tank 18, Electronic Power System Control Modules 19, An Electric Control 20, A Heater Reservoir Tank 21, A Coolant Overflow Tank 22, Coolant/Heater Battery Rack Support 23, Battery Thermal Management System Reservoir 24, Battery Thermal Management System Reservoir Tanks 25, An Electrical Battery Rack Top Cover 26, Over-Engine Crossmembers 27, Cable/Hose Management Plates 28, Electrical Rack Base Covers 29, Electrical Rack Base Inner Fender Guard Covers 30, Right Rack Base Fender 31, Left Rack Base Fender 32, Radiator Inlet/Hose Standoff 33, and Tubing Spacer 34.

Thus, in one or more embodiments, a lightweight battery rack to house EV batteries for a vehicle, such as a truck, is provided. The components of such a rack are generally modular to allow for the rack to house the EV batteries in a plurality of configurations, and to be mounted in various location and orientation, such as in a variety of positions and locations on a truck chassis.

While principles and modes of operation have been explained and illustrated with regard to particular embodiments, it must be understood, however, that this may be practiced otherwise than as specifically explained and illustrated without departing from its spirit or scope.

What is claimed is:

1. A battery frame comprising:
a generally planar rear member;
a pair of opposing parallel generally planar side members extending generally orthogonally from the rear member;
a pair of opposing coplanar top flanges extending generally orthogonally to the rear member and the side members and each outwardly from a respective side member and having a plurality of apertures spaced there along;
a pair of opposing coplanar bottom flanges extending generally orthogonally to the rear member and the side members and each outwardly from a respective side member and having a plurality of apertures spaced there along and aligned with the apertures of the top flanges respective to each side; and
a pair of opposing coplanar inner flanges extending generally orthogonally to the rear member and the side members and each inwardly from a respective side member for support of a battery package disposed therein the battery frame.

2. The battery frame of claim 1 further comprising a cross support member extending between and coplanar to the pair of inner flanges.

3. The battery frame of claim 1 further comprising a pair of opposing coplanar rear flanges extending generally orthogonally to the rear member and the side members and one inwardly from a top edge of the rear member and the other from a bottom edge of the rear member.

4. The battery frame of claim 3 further comprising at least one rear reinforcement member abutting the rear member and extending between the pair of rear flanges.

5. The battery frame of claim 1 further comprising at least one side reinforcement member abutting each side member and extending between respective top and bottom flanges.

6. The battery frame of claim 1 where each side member defines a window therein.

7. The battery frame of claim 1 where the window is disposed at the end of each side member opposite the rear member.

8. The battery frame of claim 1 further comprising at least one pair of opposing connection tabs, one of each, extending laterally from a respective side member about an end opposite the rear member, and including an aperture disposed therein.

9. A battery rack assembly comprising:
a pair of battery frames, each including:
a generally planar rear member;
a pair of opposing parallel generally planar side members extending generally orthogonally from the rear member;
a pair of opposing coplanar top flanges extending generally orthogonally to the rear member and the side members and each outwardly from a respective side member and having a plurality of apertures spaced there along;
a pair of opposing coplanar bottom flanges extending generally orthogonally to the rear member and the side members and each outwardly from a respective side member and having a plurality of apertures spaced there along and aligned with the apertures of the top flanges respective to each side; and
a pair of opposing coplanar inner flanges extending generally orthogonally to the rear member and the side members and each inwardly from a respective side member for support of a battery package disposed therein the battery frame, and
where the pair of battery frames are joined at ends of respective side members opposite the rear members.

10. The battery rack of claim 9 further comprising a top cover disposed adjacent to the top flanges and having a plurality of apertures aligned with the apertures in the top flanges.

11. The battery rack of claim 10 where the top cover defines a plurality of windows for the passage of environmental or electrical utilities or controls.

12. The battery rack of claim 9 further comprising a mounting structure disposed adjacent to the bottom flanges and including upper portions having a plurality of apertures aligned with the plurality of apertures in the bottom flanges.

13. The battery rack of claim 12 where the mounting structure further includes a pair of opposing parallel mounting brackets extending in the direction between the side members for attachment to a vehicle frame.

14. The battery rack of claim 13 where mounting brackets are spaced from the upper portions with a pair of side plates extending there between.

15. The battery rack of claim 14 where at least one of the side plates defines a window providing access to space below the pair of battery frames.

16. The battery rack of claim 9 further comprising a second pair of battery frames, the second pair of battery frames, each including:
a generally planar rear member;
a pair of opposing parallel generally planar side members extending generally orthogonally from the rear member;
a pair of opposing coplanar top flanges extending generally orthogonally to the rear member and the side members and each outwardly from a respective side member and having a plurality of apertures spaced there along;
a pair of opposing coplanar bottom flanges extending generally orthogonally to the rear member and the side members and each outwardly from a respective side member and having a plurality of apertures spaced there along and aligned with the apertures of the top flanges respective to each side; and
a pair of opposing coplanar inner flanges extending generally orthogonally to the rear member and the side members and each inwardly from a respective side member for support of a battery package disposed therein the battery frame, and
where the pair of battery frames are joined at ends of respective side members opposite the rear members;
where the bottom flanges of the second battery frames are disposed adjacent to the top flanges of the first battery frames with the apertures of the bottom flanges of the second battery frames aligned with the apertures in the top flanges of the first battery frames.

17. The battery rack of claim 9 further comprising a pair of battery packages, one of each disposed in one of the battery frames and spaced apart with one another.

18. The battery rack of claim 17 where each battery package includes an electrical utility or control interface facing the spaced apart area between the battery packages.

19. The battery rack of claim 9 where the rear member of at least one of the battery frames defines a window therein to provide access to the space inside the one of the battery frames.

20. The battery rack of claim 19 where a battery package is disposed within the one of the battery frames and includes an electrical utility or control interface facing the rear member window or through the rear member window.
